(19) United States
(12) Patent Application Publication
(10) Pub. No.: US 2007/0288937 A1
(43) Pub. Date: Dec. 13, 2007

(54) Virtual Device Driver

(75) Inventors: Olumuyiwa M. Durojaiye, Bothell, WA (US); Bryan D. Scott, Bothell, WA (US); Steven P. Dodge, Sammamish, WA (US)

Correspondence Address: BANNER & WITCOFF, LTD.;ATTORNEYS FOR CLIENT NOS. 003797 & 013797, 1100 13th STREET, N.W., SUITE 1200, WASHINGTON, DC, 20005-4051, US

(73) Assignee: MICROSOFT CORPORATION, Redmond, WA (US)

(21) Appl. No.: 11/382,119

(22) Filed: May 8, 2006

(51) Int. Cl. G06F 9/44

(52) U.S. Cl. 719/327

(57) ABSTRACT

Performance of automated testing and diagnosis of software associated with a digitizer is provided. Testing involves receiving a request packet from a driver of a digitizer. The request packet may be stored in a queue of a virtual driver associated with the driver of the digitizer. A data file configured for the driver of the digitizer is detected and used by the virtual driver. Data responsive to the request packet is sent to the driver of the digitizer upon determining that the data file has been detected, and the responsive data is subsequently processed for testing or diagnostic purposes by the driver for the digitizer as well as system and application software layers above the driver.

### BACKGROUND

As the use of computers in both the workplace and home has increased, so has the need to develop user friendly computers. One type of computer that creates a user friendly environment for interaction purposes is a digitizer, such as a tablet type computer. A tablet style computer allows a user to interact with a computer as if writing on a piece of paper or other flat surface.

As a user writes across the display surface of a digitizer with some type of input device, such as a stylus, digital ink is captured for where the user has positioned the stylus. Application programs, such as OneNote by Microsoft® Corporation of Redmond, Wash. run on an operating system. An application program takes the input strokes received from the user writing on the display surface and processes the data to perform some function. For example, the input strokes may be used by an application program to produce letters and words written by the user in a word processing manner.

Like any type of computer related device, testing is necessary to ensure that time and research expenses put into development of a product by a manufacturer yields the desired result or behavior. Various levels of testing may be done to ensure that a device will operate efficiently and correctly when released. One component to test is a device driver associated with a particular hardware input device. For example, a device driver for a digitizer may need to be tested.

Today, testing of a device driver for a device, such as a digitizer, may only be implemented manually.

### BRIEF SUMMARY

The following presents a simplified summary of the invention in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

Aspects of the present invention are directed to a method and media for performing automated testing and diagnosis of software in multiple architectural layers above a hardware component such as a digitizer. A virtual device driver is connected to a software system in place of a device driver for the physical connection. A data file containing signals normally recognized by software layers above as originating from hardware, either the driver for the physical device or the application software running above that, is detected by the virtual driver. As the driver or software sends request packets intended for the hardware, the virtual driver stores those packets in a queue, and sends response packets according to the data file, and automated testing or diagnostic simulation ensues.

Other aspects of the present invention include reading a portion of the data file based upon the packet request and sending the portion as part of responsive data to a driver of a digitizer. The portion of the data may include a code path corresponding to corrupt or other invalid data. Still other aspects of the present invention are directed to an error generation system. A virtual driver may be set to initiate a fail operation in response to receipt of a particular/specific request packet, such as an “n”th or “5”th request packet or a location related request packet. When a request packet from a driver of a digitizer is determined to be the particular/specific request packet, a fail operation may be initiated where corrupt or other invalid data is sent in response to the request packet for testing of the software.

Still other aspects of the present invention may be used as a diagnostic tool to aid in determining the root cause of a system malfunction. By simulating what a digitizer is sending through software layers, a user may determine whether an issue is reproducible without the need for a signal emanating from the hardware.

### BRIEF DESCRIPTION OF THE DRAWINGS

A more complete understanding of aspects of the present invention and the advantages thereof may be acquired by referring to the following description in consideration of the accompanying drawings, in which like reference numbers indicate like features, and wherein:

FIG. 1 illustrates a schematic diagram of a general-purpose digital computing environment in which certain aspects of the present invention may be implemented.

FIG. 2 illustrates a method for data movement from an input device to an application program.

FIG. 3 illustrates a configuration of a device driver stack for a pen type digitizer.

FIG. 4 illustrates a configuration of a device driver stack for a pen digitizer in accordance with at least one aspect of the present invention.

FIG. 5 illustrates a method for performing automated testing of a digitizer in accordance with at least one aspect of the present invention.

FIG. 6 illustrates a method for communication between a pen driver and a virtual serial driver in accordance with at least one aspect of the present invention.

FIG. 7 illustrates a method for performing automated error data simulation of a digitizer in accordance with at least one aspect of the present invention.

FIG. 8 illustrates an example virtual driver configuration in accordance with at least one aspect of the present invention.

### DETAILED DESCRIPTION

In the following description of the various embodiments, reference is made to the accompanying drawings, which form a part hereof, and in which is shown by way of illustration various embodiments in which features may be practiced. It is to be understood that other embodiments may be utilized and structural and functional modifications may be made.

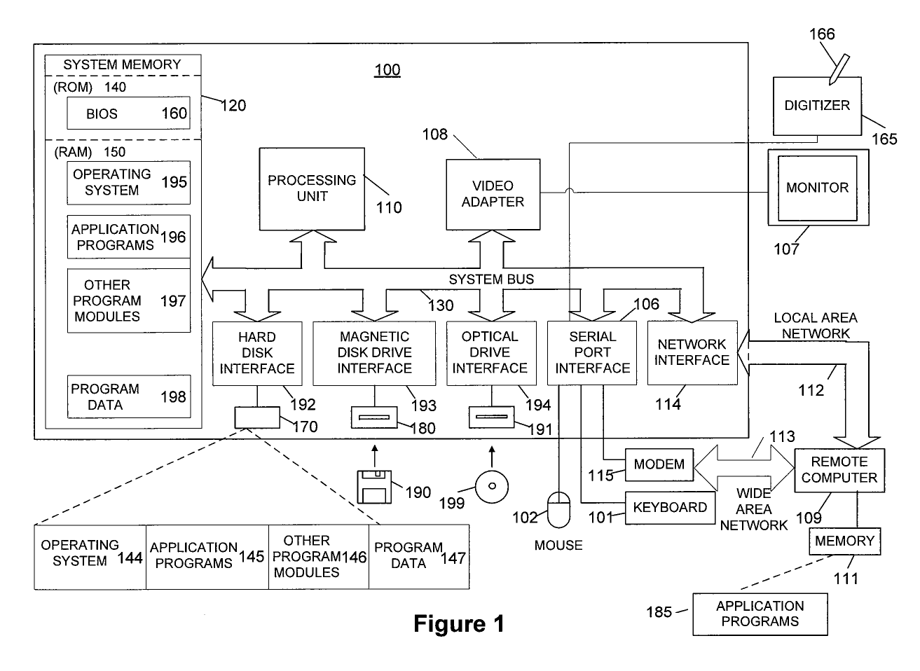

FIG. 1 illustrates an example of a suitable computing system environment on which aspects of the invention may be implemented. The computing system environment is only one example of a suitable computing environment and is not intended to suggest any limitation as to the scope of use or functionality of the invention. Neither should the computing system environment be interpreted as having any dependency nor requirement relating to any one or combination of components illustrated in the exemplary computing system environment.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an illustrative system for implementing the invention includes a general-purpose computing device in the form of a computer 100. Components of computer 100 may include, but are not limited to, a processing unit 110, a system memory 120, and a system bus 130 that couples various system components including the system memory to the processing unit 110. The system bus 130 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 100 typically includes a variety of computer readable media. Computer readable media can be any available media that can be accessed by computer 100 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 100. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 120 includes computer storage media in the form of volatile and/or nonvolatile memory such as ROM 140 and RAM 150. A basic input/output system 160 (BIOS), containing the basic routines that help to transfer information between elements within computer 100, such as during start-up, is typically stored in ROM 140. RAM 150 typically contains data and/or program modules that are immediately accessible to and/or presently being operated on by processing unit 110. By way of example, and not limitation, FIG. 1 illustrates operating system 195, application programs 196, other program modules 197, and program data 198.

The computer 100 may also include other removable/non-removable, volatile/nonvolatile computer storage media. By way of example only, FIG. 1 illustrates a hard disk drive 170 that reads from or writes to non-removable, nonvolatile magnetic media, a magnetic disk drive 180 that reads from or writes to a removable, nonvolatile magnetic disk 190, and an optical disc drive 191 that reads from or writes to a removable, nonvolatile optical disc 199 such as a CD ROM or other optical media. Other removable/non-removable, volatile/nonvolatile computer storage media may be used. The hard disk drive 170 is typically connected to the system bus 130 through a non-removable memory interface such as interface 192, and magnetic disk drive 180 and optical disc drive 191 are typically connected to the system bus 130 by a removable magnetic disk drive interface 193 and a removable optical drive interface 194.

The drives and their associated computer storage media discussed above and illustrated in FIG. 1, provide storage of computer readable instructions, data structures, program modules and other data for the computer 100. In FIG. 1, for example, hard disk drive 170 is illustrated as storing operating system 144, application programs 145, other program modules 146, and program data 147. Note that these components can either be the same as or different from operating system 195, application programs 196, other program modules 197, and program data 198. Operating system 144, application programs 145, other program modules 146, and program data 147 are given different numbers here to illustrate that, at a minimum, they are different copies. A user may enter commands and information into the computer 100 through input devices, such as a keyboard 101, and pointing device 102. These and other input devices are often connected to the processing unit 110 through a serial port interface 106 that is coupled to the system bus 130, but may be connected by other interface and bus structures, such as a parallel port, game port or a universal serial bus (USB). A monitor 107 or other type of display device is also connected to the system bus 130 via an interface, such as a video adaptor 108. In addition to the monitor, computers may also include other peripheral output devices such as speakers and printer (not shown), which may be connected through an output peripheral interface.

In one illustrative embodiment, a pen digitizer 165 and accompanying pen or stylus 166 are provided in order to digitally capture freehand input. Although a direct connection between the pen digitizer 165 and the serial port interface 106 is shown, in practice, the pen digitizer 165 may be coupled to the processing unit 110 directly, via a parallel port or other interface and the system bus 130 as known in the art. Furthermore, although the digitizer 165 is shown apart from the monitor 107, it is preferred that the usable input area of the digitizer 165 be co-extensive with the display area of the monitor 107. Further still, the digitizer 165 may be integrated in the monitor 107, or may exist as a separate device overlaying or otherwise appended to the monitor 107. In accordance with aspects of the present invention, one or more components of the computer 100 and/or other components in FIG. 1 may be included within the digitizer 165. It should be understood by those skilled in the art that although the examples described herein relate to a pen-type digitizer, aspects of the present invention are not so limited and may include other digitizers that are sensitive to finger touch and/or other proximity or physical contact.

The computer 100 may operate in a networked environment using logical connections to one or more remote computers, such as a remote computer 109, that typically include many or all of the elements described above relative to the computer 100, although only a memory storage device 111 has been illustrated in FIG. 1. The logical connections depicted in FIG. 1 include a local area network (LAN) 112 and a wide area network (WAN) 113, but may also include other networks. Such networking environments are commonplace in offices, enterprise-wide computer networks, intranets and the Internet.

When used in a LAN networking environment, the computer 100 is connected to the LAN 112 through a network interface or adapter 114. When used in a WAN networking environment, the computer 100 typically includes a modem 115 or other means for establishing communications over the WAN 113, such as the Internet. The modem 115, which may be internal or external, may be connected to the system bus 130 via the user input interface 106, or other appropriate mechanism. In a networked environment, program modules depicted relative to the computer 100, or portions thereof, may be stored in the remote memory storage device. By way of example, and not limitation, FIG. 1 illustrates remote application programs 185 as residing on memory device 111. It will be appreciated that the network connections shown are exemplary and other means of establishing a communications link between the computers may be used.

It will be appreciated that the network connections shown are exemplary and other means of establishing a communications link between the computers can be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

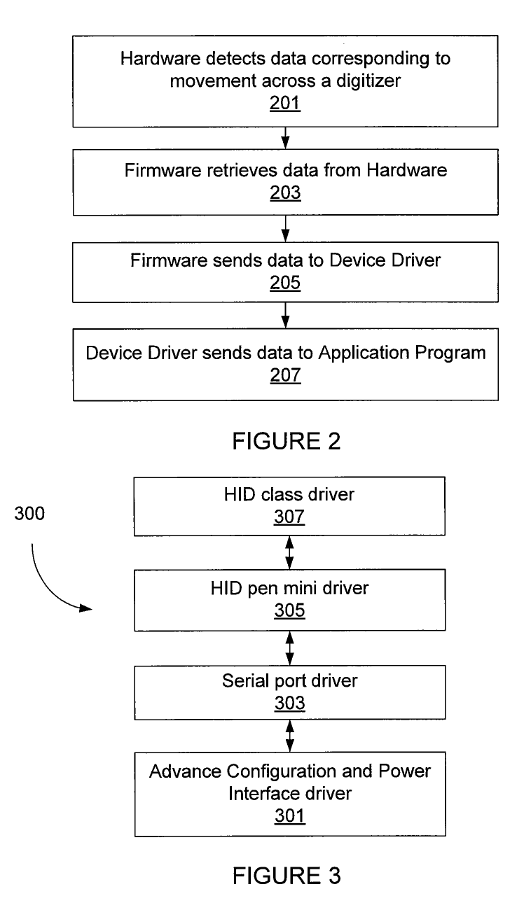

FIG. 2 illustrates a method for data movement from an input device to an application program. Traditionally, for testing or analyzing software dependent upon a digitizer type device, manual testing is required. A pen or stylus, such as stylus 166, is used to touch a display screen of the digitizer, such as digitizer 165. At step 201, hardware detects, e.g., measures, data corresponding to movement across the digitizer 165. At step 203, the firmware retrieves data from the hardware. At step 205, the firmware sends data through a hardware/software interface, such as a serial or USB port, to a device driver before, at step 207 the device driver sends data to an application program running on an operating system, such as operating system 195. Thus, without direct input, i.e., physical interaction, program code in a device driver is not executed.

FIG. 3 illustrates a configuration of a device driver stack 300 for a pen type digitizer, such as digitizer 165. A device driver stack for a pen type digitizer includes the following members, an Advanced Configuration and Power Interface (ACPI) driver (physical device driver) 301, a serial port driver (function driver) 303, a Human Interface Device (HID) (pen) mini driver (filter driver) 305, and a HID class driver (upper filter driver) 307. The HID class driver and HID mini driver are considered to be one unit in the driver stack. The ACPI driver 301 is a physical power management driver to allow a computer to control power usage of peripheral units. The serial port driver 303 is a driver that handles communication between a serial port and the operating system. The HID pen mini driver 305 provides the interface between a bus driver, such as a universal serial bus (USB) driver, and the 10 manager (OS component). The HID class driver 307 defines how data is extracted from a HID compliant pen type input device.

When interacting with a digitizer, such as digitizer 165, a user causes data to be generated by the digitizer. The digitizer 165 generates interrupts when it has data available. These interrupts are handled by a serial port driver, such as serial port driver 303, which sends the data up the driver stack, such as driver stack 300. Between the upper filter mini driver, such as HID pen mini driver 305, and the HID class driver, such as HID class driver 307, the data is parsed and sent to any application program that has requested to receive data from the digitizer 165.

A device driver for a digitizer 165 expects data directly from the hardware of the device. For example, when a user moves a stylus 166 across the display screen of the digitizer 165, captured data is sent from the hardware to the device driver of the device. Testing of the device driver requires direct interaction, e.g., a user moving the stylus across the digitizer.

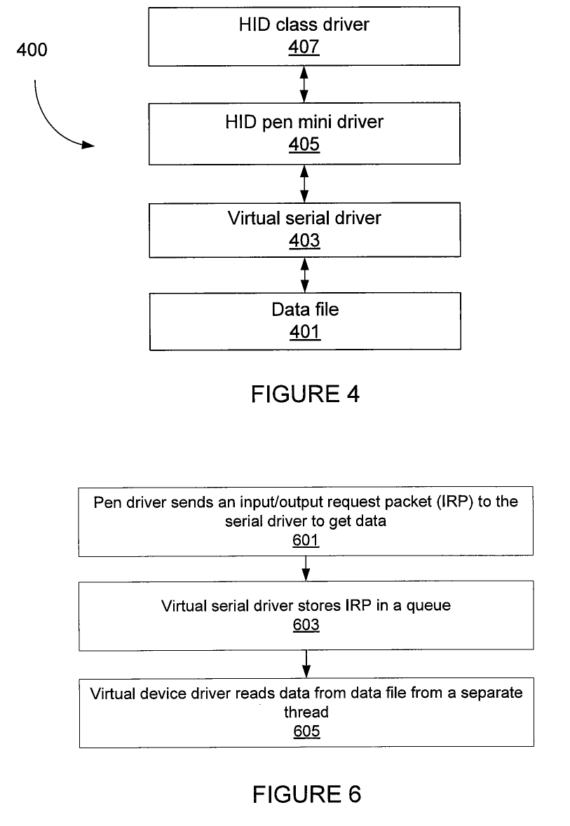

In accordance with aspects of the present invention, a virtual serial driver is positioned below a human interface device (HID) pen mini driver to simulate the data input from a device by reading data from a data file and sending it up the device stack. FIG. 4 illustrates a configuration of a device driver stack 400 for a pen digitizer, such as digitizer 165, in accordance with at least one aspect of the present invention. A device driver stack for a pen type digitizer 165 in accordance with at least one aspect of the present invention includes the following members, a data file 401, a virtual serial driver 403, a HID (pen) mini driver 405, and a HID class driver 407. Simulation data is stored in data file 401 and read by the virtual serial driver 403 when read/write interrupt requests are received. The virtual serial driver 403 effectively replaces a serial port driver. The method of testing is described more fully below.

Aspects of the present invention address testing/diagnosing issues in a device driver that receives input from a serial port. Other aspects of the present invention provide for a virtual driver to virtualize a hardware interface for a hardware type that is being tested. For example, in testing/diagnosing audio software/driver that processes input from a microphone, aspects of the present invention may provide a virtual audio driver corresponding to the hardware interface thru which the microphone input usually travels.

In this configuration, a pen driver may be tested using data that is normally generated manually. In addition, invalid device data may be simulated. The virtual serial driver may also simulate error scenarios that are not related to data. In addition, aspects of the present invention allow for the testing of a device driver on platforms that do not have real digitizer hardware readily available.

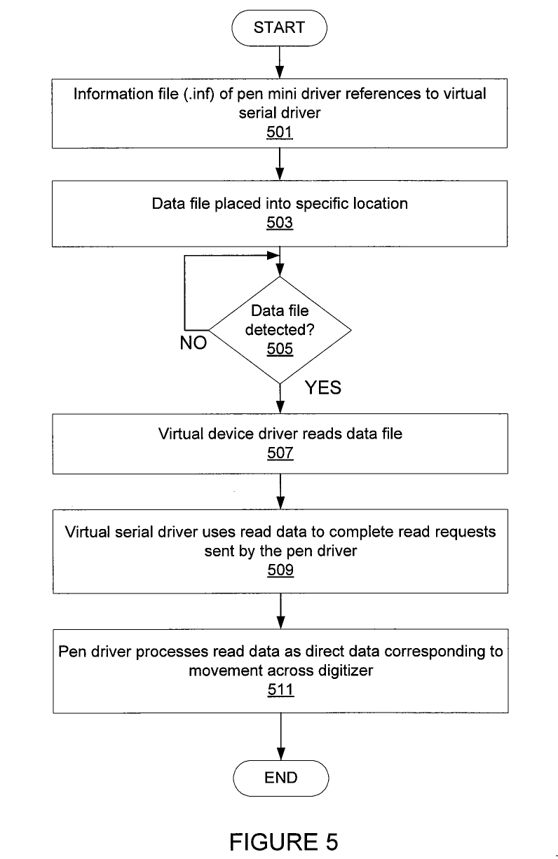

FIG. 5 illustrates a method for performing automated testing of a digitizer in accordance with at least one aspect of the present invention. The process starts at step 501 where the system loads the virtual driver instead of the real driver. In one example, an information file (.inf) of a pen mini driver may be referenced to a virtual serial driver as opposed to a real serial port driver. Once the virtual serial driver is loaded, at step 503, a data file is placed in a specific location in which the virtual serial driver is expected to find the data file. Examples of such a specific location include a directory on a hard drive of a local computer or a network or Internet storage location. The process moves to step 505 where a determination is made as to whether the data file has been detected by the virtual serial driver. If not, step 505 is repeated. If the data file is detected in step 505, the virtual serial driver starts reading the data file in step 507. Proceeding to step 509, the virtual serial driver uses the read data to complete read requests sent by the pen driver. Finally, at step 511, the pen driver processes the read data as direct data corresponding to movement across a digitizer. This gives a pen driver the impression that the pen driver is actually getting data from a digitizer. In accordance with aspects of the present invention, driver to driver communication is utilized as opposed to driver to application communication.

FIG. 6 illustrates a method for communication between a pen driver and a virtual serial driver in accordance with at least one aspect of the present invention. At step 601, a pen driver sends an input/output request packet (IRP) to a serial driver to get data. In accordance with aspects of the present invention, the serial driver is replaced with the virtual serial driver. At step 603, the virtual serial driver receives the IRP and stores the request in a queue. Finally, at step 605, the virtual serial driver reads data from a data file from a separate system thread.

A separate thread may be used for at least two reasons. Firstly, as this operation is performed in the kernel mode, as opposed to the user mode, a data file is read at a passive or low-priority level. Those skilled in the art should understand that keeping the use of processing of a data file at a lower priority helps to prevent a virtual device driver's use of the data file which may reside in the file system from becoming a bottleneck for the responsiveness/performance of the entire system. The use of a data file is a low priority so the entire device driver does not respond to IRPs from a pen driver in a low-priority fashion.

Secondly, by using a second system thread, asynchronous data processing is enabled, thereby more accurately simulating actual input from a digitizer, as hardware typically operates in an asynchronous fashion from the software layers above. In the thread where the data is being read from the data file, the virtual driver may check for pending read IRPs. If any are available, the virtual driver uses the data from the data file to complete the read request.

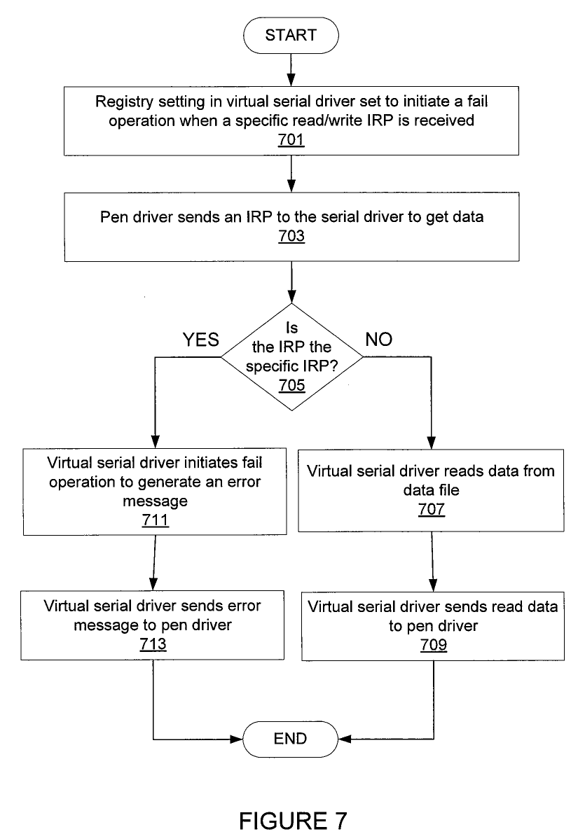

FIG. 7 illustrates a method for performing automated error data simulation of a digitizer in accordance with at least one aspect of the present invention. In accordance with at least one aspect of the present invention, a virtual serial driver may include a registry setting that specifies an indication as to when to initiate a fail operation, such as to fail upon receipt of a particular/specific request packet. Other examples include the “n”th read/write IRP that the virtual serial driver receives. At step 701, the virtual serial driver is pre-configured, such as through a registry entry or other mechanism, to initiate a fail operation when the specific read/write IRP is received. For example the virtual serial driver may be configured to send corrupted or other invalid data for every 5^{th} read/write IRP received. At step 703, a pen driver being tested sends an IRP to the serial port driver requesting data.

Moving to step 705, before processing of the input/output request packet, the virtual driver determines whether the current request packet is the specific request packet. If the current request from step 703 is not the specific request packet, the process moves to step 707 where the virtual serial driver reads data from the data file. At step 709, the virtual serial driver sends the read data to the pen driver as requested in step 703 and the process ends. Returning to step 705, if the current request packet in step 703 is the specific request packet, as determined in step 705, the virtual serial driver will initiate a fail operation to generate an error message, such as corrupted or other invalid data in step 711. Finally, at step 713, the virtual serial driver sends the error message to the pen driver. This ensures that the pen driver may be tested for proper error handling. In one aspect, the data corresponding to the invalid data may be stored in the data file as well. Whenever data is read from the data file, the virtual driver reads the data sequentially. Therefore, if invalid data is needed in the data file, the creator of the data file takes the sequence into consideration.

In accordance with other aspects of the present invention, a virtual serial driver may perform basic handling of Plug and Play (PnP) input/output request packets (IRP) and power management IRPs. Differing from a real serial driver, a virtual serial driver does not necessitate the capability of being a power policy owner. However, being a power policy owner allows a virtual driver to be a stimulus for testing other parts of a system, such as the responsiveness of the system when a pen is used to wake up the system from a power-saving state. A virtual serial driver does not require this capability as a HID class driver may act as the power policy owner for HID mini-drivers, such as a pen driver.

In accordance with aspects of the present invention, the content of a data file is device specific. As each device driver, such as one digitizer manufacturer compared to another, may be different, a particular data file for use with the virtual serial driver may be different. In one aspect, an initial data file may be generated by manually recording binary data as the data is captured by a real device. The data may then be stored in the data file. In another aspect, a portion of data may be manually recorded and then replicated and/or processed for completion of a total data file.

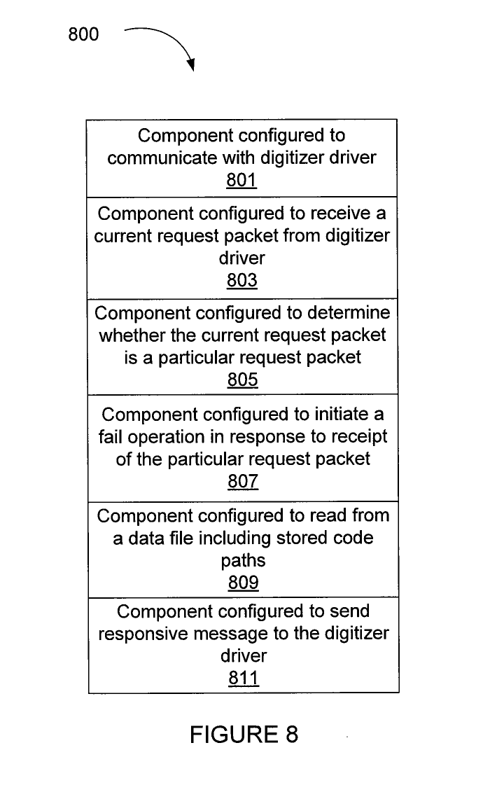

FIG. 8 illustrates an example virtual driver configuration 800 in accordance with at least one aspect of the present invention. The virtual driver configuration 800 is shown to include at least one component 801 configured to communicate with a driver of a digitizer. At least one component 803 is configured to receive one or more request packets, including a current request packet, from the driver of the digitizer. The request packet may be an input/output request packet (IRP). At least one component 805 is configured to determine whether the current request packet is a particular request packet. At least one component 807 is configured to initiate a fail operation in response to receipt of the particular request packet. A fail operation may include generating an error message and/or extracting data from a data file at a particular location. Whenever data is read from the data file, the virtual driver reads the data sequentially. Therefore, if invalid data is needed in the data file, the creator of the data file takes the sequence into consideration. At least one component 809 is configured to read from a data file including stored code paths. The data file may be associated with the digitizer. Finally, at least one component 811 is configured to send a responsive message to the driver of the digitizer.

Example virtual driver configuration 800 may include one or more computer-readable media storing computer-readable instructions for performing automated testing of the digitizer. The virtual driver configuration 800 may be downloaded from a separate location through a transmission mechanism, such as the Internet and/or may be store on a computer-readable medium such as an optical disc. In addition, it should be understood by those skilled in the art that two or more of the various components 801-811 described with reference to FIG. 8 may be configured as the same component. For example, component 801 and component 811 may include the same or similar modules for communication with a digitizer driver.

The following example provides an illustrative implementation of certain aspects of the present invention. Company A has invested a great deal of time and money in development of a new digitizer. For this example, the digitizer is a new tablet type computer that uses a stylus for one type of input. An engineer at Company A may create a data file for the new digitizer by manually generating input strokes and storing them in the data file. Once a virtual serial driver is loaded, testing may be performed in which the digitizer driver interprets data received from the virtual serial driver as data received directly from manual movement of the stylus across a surface of the digitizer. As described herein, code paths may be represented in the data file to test for previous code bugs. For example, if a code path was known to create an error in operation of a digitizer in a previous firmware version of the digitizer, when testing a newer firmware version, the same code path may be used to determine whether the code bug still exists.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A computer-readable medium configured to store computer-readable instructions for performing automated testing of a digitizer driver, that when executed by a computer, cause the computer to perform steps of:
receiving, at a virtual driver, a request packet from a driver of the digitizer;
storing the request packet in a queue of the virtual driver associated with the device driver;
determining whether a data file configured for the driver of the digitizer has been detected by the virtual driver;
sending responsive data to the driver of the digitizer in response to determining that the data file has been detected; and
processing the responsive data by the driver of the digitizer.

2. The computer-readable medium of claim 1, wherein the computer-readable instructions further cause the computer to perform steps of:
referencing the virtual driver to the driver of the digitizer; and
loading the virtual driver.

3. The computer-readable medium of claim 2, wherein the step of referencing includes changing an information file associated with the driver of the digitizer to reference the virtual driver.

4. The computer-readable medium of claim 1, wherein the responsive data includes the portion of the data file.

5. The computer-readable medium of claim 4, wherein the computer-readable instructions further cause the computer to perform a step of reading a portion of the data file based upon the packet request.

6. The computer-readable medium of claim 5, wherein the portion of the data file includes a code path corresponding to invalid data.

7. The computer-readable medium of claim 1, wherein the step of processing includes performing an operation in the digitizer to test the digitizer.

8. The computer-readable medium of claim 1, wherein the computer-readable instructions further cause the computer to perform a step of setting a registry of the virtual driver to initiate a fail operation in response to receipt of a specific request packet.

9. The computer-readable medium of claim 8, wherein the responsive data includes a code path corresponding to invalid data.

10. The computer-readable medium of claim 9, wherein in response to determining that the request packet is the specific request packet, the computer-readable instructions further causing the computer to perform a step of initiating a fail operation.

11. The computer-readable medium of claim 10, wherein the step of initiating a fail operation includes reading a specific portion of the data file based upon the packet request.

12. The computer-readable medium of claim 9, wherein in response to determining that the request packet is not the specific request packet, the computer-readable instructions further causing the computer to read a portion of the data file based upon the packet request.

13. The computer-readable medium of claim 12, wherein the responsive data includes the portion of the data file.

14. The computer-readable medium of claim 1, wherein the request packet is an input/output request packet.

15. One or more computer-readable media storing computer-readable instructions for communicating with a driver for a digitizer, the computer-readable instructions for performing automated testing of the digitizer, the one or more computer-readable media comprising:
at least one component configured to communicate with the driver of the digitizer;
at least one component configured to receive a current request packet from the driver of the digitizer;
at least one component configured to determine whether the current request packet is a particular request packet;
at least one component configured to initiate a fail operation in response to receipt of the particular request packet; and
at least one component configured to send a responsive message to the driver of the digitizer.

16. The one or more computer-readable media of claim 15, wherein the responsive message includes a code path corresponding to invalid data when the current request packet is the particular request packet.

17. The one or more computer-readable media of claim 15, further comprising at least one component configured to read from a data file including stored code paths.

18. The one or more computer-readable media of claim 17, wherein the responsive message includes a portion of the data file when the current request packet is not the particular request packet.

19. The one or more computer-readable media of claim 15, wherein the at least one component configured to initiate a fail operation is further configured to read a specific portion of a data file based upon the current request packet.

20. A computer-implemented method for performing automated testing of a digitizer driver, the method comprising steps of:
referencing a virtual driver to a driver of the digitizer;
setting a registry of the virtual driver to initiate a fail operation in response to receipt of a specific request packet;
receiving a plurality of request packets from the driver of the digitizer;
storing the plurality of request packets in a queue of the virtual driver;
determining whether a data file associated with the virtual driver has been detected by the virtual driver;
determining whether one of the plurality of request packets in the queue is the specific request packet received by the virtual driver;
initiating a fail operation as a response for a particular request packet upon determining that the particular request packet is the specific request packet;
for each of the other request packets of the plurality of request packets that is not the specific request packet, reading a portion of the data file based upon the request packet; and
for each of the other request packets of the plurality of request packets that is not the specific request packet, sending a response to the driver of the digitizer.
